(19) United States
(12) Patent Application Publication
(10) Pub. No.: US 2013/0265292 A1
(43) Pub. Date: Oct. 10, 2013

(54) APPARATUS FOR DRIVING DISPLAY PANEL AND DISPLAY DEVICE USING SAME

(71) Applicant: FITIPOWER INTEGRATED TECHNOLOGY, INC., Hsinchu City (TW)

(72) Inventors: CHEN-CHI YANG, Hsinchu (TW); MENG-WEI CHUANG, Hsinchu (TW); LI-SHEN CHANG, Hsinchu (TW)

(73) Assignee: FITIPOWER INTEGRATED TECHNOLOGY, INC., Hsinchu City (TW)

(21) Appl. No.: 13/855,689

(22) Filed: Apr. 2, 2013

(30) Foreign Application Priority Data
Apr. 5, 2012 (TW) 101112125

(51) Int. Cl. G09G 3/36

(52) U.S. Cl. CPC G09G 3/3696
USPC 345/212; 345/87

(57) ABSTRACT

An apparatus for driving a display panel includes an output terminal for outputting driving voltages to the display panel, a source driver for intermittently outputting data voltages to the driving voltage output terminal and at least one charge sharing branch connected to the driving voltage output terminal. Each of the at least one charge sharing branch includes a charge sharing capacitor and a charge sharing switch connected in series between the driving voltage output terminal and ground, enabling the accumulation and supply to the display of the necessary reverse driving voltages, from a single intermittent source driver instead of from two independently-powered opposite polarity sources.

### BACKGROUND

1. Technical Field

The present disclosure relates to display panel driving technologies, and more particularly, to an apparatus for driving a display panel, and a display device using the apparatus.

2. Description of Related Art

Liquid crystal displays (LCDs) utilize liquid crystal molecules to control light transmissivity of pixel units, where the liquid crystal molecules in a pixel unit tilt to a corresponding angle in accordance with a driving voltage applied to the pixel unit. The driving voltage is normally provided by a source driver.

In order to protect the liquid crystal molecules from decay or damage, a typical LCD may employ a polarity inversion driving method. In the polarity inversion driving method, each pixel unit is provided with a positive driving voltage in a frame period, and in a next frame period, the driving voltage provided to the pixel unit is changed to be negative. In other words, the polarity inversion driving method requires the source driver to output driving voltages having two different polarities in two consecutive frame periods. This causes power consumption of the typical LCD to increase.

What is needed is a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views, and all the views are schematic.

FIG. 1 is a block diagram of a display device according to one embodiment of the present disclosure.

FIG. 2 shows driving periods of the display device of FIG. 1.

FIG. 3 is a block diagram of a display device according to another embodiment of the present disclosure.

### DETAILED DESCRIPTION

Reference will be made to the drawings to describe certain exemplary embodiments of the present disclosure.

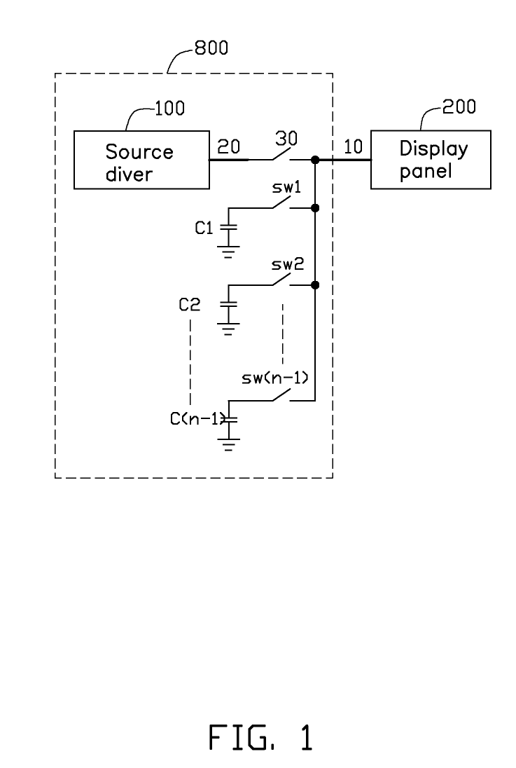

FIG. 1 is a block diagram of a display device according to one embodiment of the present disclosure. The display device includes a display panel 200 and an apparatus 800 for driving the display panel 200. The display panel 200 may be a flat panel such as an LCD panel.

The apparatus 800 includes a source driver 100, a control switch 30, a plurality of charge sharing capacitors C1, C2, C3, . . . , C(n−1), a plurality of charge sharing switches sw1, sw2, sw3, . . . , sw(n−1), and a driving voltage output terminal 10. The output terminal 10 is electrically connected to the display panel 200, and outputs driving voltages to the display panel 200.

The source driver 100 includes a data voltage output terminal 20 for outputting data voltages. The control switch 30 is connected between the data voltage output terminal 20 and the driving voltage output terminal 10. Each of the charge sharing capacitors C1, C2, C3, . . . , C(n−1) corresponds to a charge sharing switch sw1, sw2, sw3, . . . , sw(n−1), and in this embodiment, each one of the charge sharing capacitors C1, C2, C3, . . . , C(n−1) and the corresponding charge sharing switch sw1, sw2, sw3, . . . , sw(n−1) is connected in series between the driving voltage output terminal 10 and ground, and cooperatively form a charge sharing branch. Accordingly, a plurality of charge sharing branches are connected in parallel and formed in the apparatus 800.

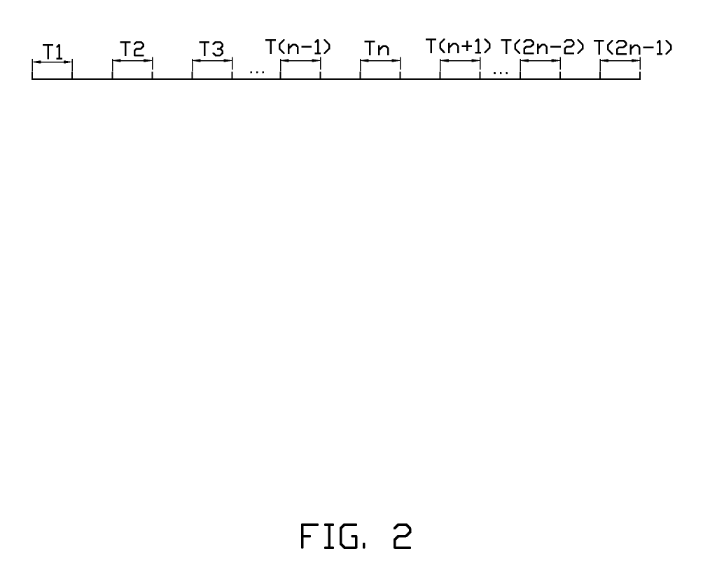

Referring to FIG. 2, in each driving period for the display panel, the source driver 100 may first output, via the data voltage output terminal 20, data voltages V1, V2, V3, . . . , V(n−1), Vn in respective time periods T1, T2, T3, . . . , T(n−1), Tn, and then secondly output data voltages V(n−1), V(n−2), V(n−3), . . . , V2, V1 in respective time periods T(n+1), T(n+2), T(n+3), . . . , T(2n-1). In this embodiment, the data voltages V1 to Vn decrease gradually, for example, the data voltages V1 to Vn may be 30V, 25V, 15V, . . . , 0V. The time periods T1 to T(2n−1) are non-consecutive time periods, and these non-consecutive time periods are defined as data voltage outputting periods T1 to T(2n−1) in the present disclosure. Moreover, since the data voltage outputting periods T1 to T(2n−1) are non-consecutive, a plurality of time periods in which no data voltage is being output from the source driver 100 alternates in time with the data voltage outputting periods T1 to T(2n−1). These time periods of zero voltage output (or no data voltage output) are defined as charge sharing periods in the present disclosure.

At the data voltage outputting periods T1 to T(2n−1), the control switch 30 is switched on under the control of an external control signal. Thus, the data voltages V1, V2, V3, . . . , V(n−1), Vn, V(n−1), V(n−2), V(n−3) . . . , V2, V1, which are output by the source driver 100, are transmitted to the driving voltage output terminal 10 and then output to the display panel 200 for the duration of the data voltage outputting periods T1 to T(2n−1). At the charge sharing periods, the control switch 30 is switched off and the charge sharing switches sw1 to sw(n−1) are switched on in sequence under the control of the external control signal, such that the charge sharing capacitors C1 to C(n−1) feed their charges in turn to the display panel 200.

Specifically, at a first data voltage output period T1, the control switch 30 is switched on, and the first data voltage V1 provided by the source driver 100 is output to the display panel 200; after period T1, at a first charge sharing period between T1 and T2, the first charge sharing switch sw1 is switched on, and thus the first charge sharing capacitor C1 feeds the charge therein to the display panel 200; at a second data voltage output period T2, the control switch 30 is switched on again, and the second data voltage V2 provided by the source driver 100 is output to the display panel; at a second charge sharing period between T2 and T3, the second charge sharing switch sw2 is switched on, and the second charge sharing capacitor C2 feeds the charge therein to the display panel 200; the operation of the apparatus 800 repeats and cycles in the above-mentioned manner, and at a (2n−1)th data voltage outputting period T(2n−1), the control switch 30 is switched on, and the source driver 100 re-outputs the first data voltage V1 to the display panel 200.

In the display device according to the present disclosure, because the charge sharing capacitors C1, C2, C3, . . . , C(n−1) can share their charges with the display panel 200 during the charge sharing periods, the source driver 100 merely needs to output the data voltages discontinuously, during the data voltage outputting periods. As such, the power consumption of the source driver 100 is significantly reduced.

Furthermore, in the display device according to the present disclosure, the number of the charge sharing branches may be designed as needed. In one embodiment, the apparatus 800 may only include one charge sharing branch, i.e., n=2, and thus a single capacitor C1 and a single second control switch sw1 are included in the apparatus 800. Accordingly, the first control switch 30 and the second control switch sw1 are alternately switched on.

In another embodiment, the apparatus 800 may include two charge sharing branches, i.e., n=3, thus a first charge sharing branch (including a first charge sharing capacitor C1 and a first charge sharing switch sw1) and a second charge sharing branch (including a second charge sharing capacitor C2 and a second charge sharing switch sw2) are connected between the driving voltage output terminal 10 and the ground. Assuming the source driver 100 outputs sequential data voltages 30V, 15V, 0V, 15V, 30V during the respective data voltage output periods T1, T2, T3, T4, T5, and capacitance of each of the first and second charge sharing capacitors C1, C2 is substantially equal to an equivalent capacitance of the display panel 200, it can be calculated that the first and second charge sharing capacitors C1, C2 reach their saturation voltages after thirteen driving periods, and the power consumption of the source driver 100 will be reduced by 33.3% from the 14th driving period onwards. Alternatively, for the same function of the source driver 100, but the capacitance of each of the first and second charge sharing capacitors C1, C2 is about five times the equivalent capacitance of the display panel 200, it can be calculated that the first and second charge sharing capacitors C1, C2 reach their saturation voltages after forty driving periods, and the power consumption of the source driver 100 will be reduced by 45.3% from the 41th driving period onwards.

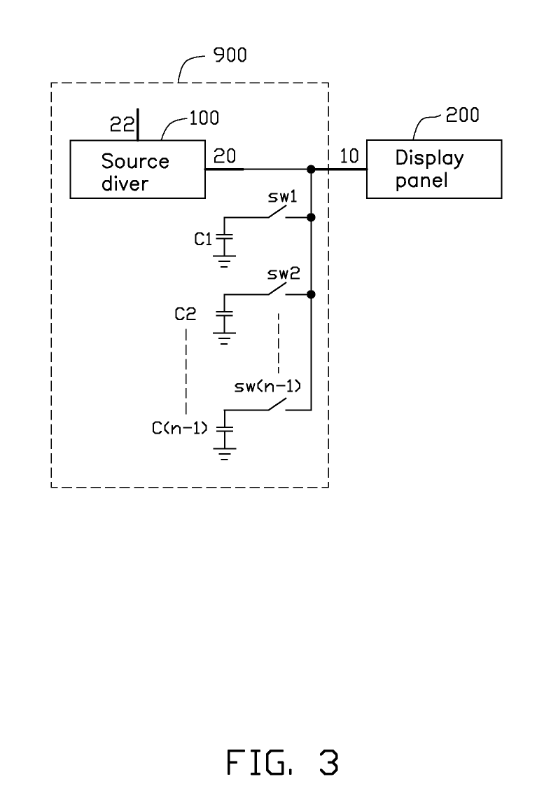

Referring to FIG. 3, a block diagram of a display device according to another embodiment of the present disclosure is shown. The display device as illustrated in FIG. 2 is similar to the above-described display device as illustrated in FIG. 1; however, in the display device as illustrated in FIG. 3, the data voltage output terminal 20 of a source driver 100 of the driving apparatus 900 is connected to an output terminal 10 with no control switch, for driving a display panel 200, and the source driver 100 further includes a control terminal 22. The control terminal 22 is configured to receive a control signal. The control signal controls the data voltage data output terminal 20 to be in a high-impedance state in the charge sharing periods, so as to enable the charge sharing capacitors C1 to C(n−1) to feed the charge therein to the display panel 200, and to control the data voltage data output terminal 20 to be in a low-impedance state in the data voltage outputting periods, so that the data voltages provided by the source driver 100 can still be output to the display panel 200.

It is to be further understood that even though numerous characteristics and advantages of preferred and exemplary embodiments have been set out in the foregoing description, together with details of the structures and functions of the embodiments, the disclosure is illustrative only; and changes may be made in detail, especially in the matters of shape, size and arrangement of parts within the principles of the present disclosure to the full extent indicated by the broad general meaning of the terms in which the appended claims are expressed.

What is claimed is:

1. An apparatus for driving a display panel, comprising:
a driving voltage output terminal outputting driving voltages to the display panel;
a source driver comprising a data voltage output terminal discontinuously outputting data voltages to the driving voltage output terminal; and
at least one charge sharing branch connected to the driving voltage output terminal;
wherein each of the at least one charge sharing branch comprises a charge sharing capacitor and a charge sharing switch connected in series between the driving voltage output terminal and ground.

2. The apparatus of claim 1, wherein each driving period for the display panel comprises a plurality of discontinuous data voltage output periods, and a plurality of charge sharing periods alternating with the discontinuous data voltage output periods.

3. The apparatus of claim 2, further comprising a control switch connected between the data voltage output terminal and the driving voltage output terminal, wherein the control switch is switched on at the data voltage output periods, and is switched off at the charge sharing periods.

4. The apparatus of claim 3, wherein the source driver respectively outputs a plurality of data voltages from data voltage output terminal at the data voltage output periods, and the data voltages output by the source driver decrease gradually at a part of the data voltage output periods.

5. The apparatus of claim 2, wherein the source driver further comprises a control terminal receiving a control signal, the control signal is configured to control data voltage output terminal of the source driver to be in a high-impedance state in the charge sharing periods, and be in a low-impedance state in the data voltage outputting periods.

6. The apparatus of claim 2, wherein the at least one charge sharing branch comprises a plurality of charge sharing branches connected in parallel.

7. The apparatus of claim 6, wherein charge sharing switches of the plurality of the charge sharing branches are switched on in turn at the charge sharing periods, and only one of the charge sharing switches is switched on at one charge sharing periods to enable the corresponding charge sharing capacitor to perform charge sharing with the display panel.

8. The apparatus of claim 1, wherein the at least one charge sharing branch comprises a first charge sharing branch and a second charge sharing branch, the first charge sharing branch comprises a first charge sharing switch and a first charge sharing switch, and the second charge sharing branch comprises a second charge sharing switch and a second charge sharing switch.

9. The apparatus of claim 8, wherein capacitance of each of the first charge sharing capacitor and the second charge sharing capacitor is substantially equal to an equivalent capacitance of the display panel.

10. The apparatus of claim 8, wherein capacitance of each of the first charge sharing capacitor and the second charge sharing capacitor is about five times of an equivalent capacitance of the display panel.

11. A display device, comprising:
a display panel; and
an apparatus for driving the display panel, the apparatus comprising:
a driving voltage output terminal outputting driving voltages to the display panel;
a source driver comprising a data voltage output terminal discontinuously outputting data voltages to the driving voltage output terminal; and
at least one charge sharing branch connected to the driving voltage output terminal;
wherein each of the at least one charge sharing branch comprises a charge sharing capacitor and a charge sharing switch connected in series between the driving voltage output terminal and ground.

12. The display device of claim 11, wherein each driving period for the display panel comprises a plurality of discontinuous data voltage output periods, and a plurality of charge sharing periods alternating with the discontinuous data voltage output periods.

13. The display device of claim 12, further comprising a control switch connected between the data voltage output terminal and the driving voltage output terminal, wherein the control switch is switched on at the data voltage output periods, and is switched off at the charge sharing periods.

14. The display device of claim 13, wherein the source driver respectively outputs a plurality of data voltages from data voltage output terminal at the data voltage output periods, and the data voltages output by the source driver decrease gradually at a part of the data voltage output periods.

15. The display device of claim 12, wherein the source driver further comprises a control terminal for receiving a control signal, the control signal is configured to control data voltage output terminal of the source driver to be in a high-impedance state in the charge sharing periods, and be in a low-impedance state in the data voltage outputting periods.

16. The display device of claim 12, wherein the at least one charge sharing branch comprises a plurality of charge sharing branches connected in parallel.

17. The display device of claim 16, wherein charge sharing switches of the plurality of the charge sharing branches are switched on in turn at the charge sharing periods, and only one of the charge sharing switches is switched on at one charge sharing periods to enable the corresponding charge sharing capacitor to perform charge sharing with the display panel.

18. The display device of claim 12, wherein the at least one charge sharing branch comprises a first charge sharing branch and a second charge sharing branch, the first charge sharing branch comprises a first charge sharing switch and a first charge sharing switch, and the second charge sharing branch comprises a second charge sharing switch and a second charge sharing switch.

19. The display device of claim 18, wherein capacitance of each of the first charge sharing capacitor and the second charge sharing capacitor is substantially equal to an equivalent capacitance of the display panel.

20. The display device of claim 18, wherein capacitance of each of the first charge sharing capacitor and the second charge sharing capacitor is about five times of an equivalent capacitance of the display panel.
